(19) United States
(12) Patent Application Publication
(10) Pub. No.: US 2023/0017394 A1
(43) Pub. Date: Jan. 19, 2023

(54) METHOD FOR DEPRESSURIZING PRODUCED NATURAL GAS

(71) Applicant: Dennis Wright, Ardmore, OK (US)

(72) Inventor: Dennis Wright, Ardmore, OK (US)

(21) Appl. No.: 17/535,981

(22) Filed: Nov. 26, 2021

Related U.S. Application Data
(60) Provisional application No. 63/116,783, filed on Nov. 20, 2020.

(51) Int. Cl. E21B 43/12

(52) U.S. Cl. CPC E21B 43/12

(57) ABSTRACT

A method for reducing gas pressure at or nearby a wellhead, the method for comprising the steps of

Providing an intake for high pressure natural;

Conveying the high pressure natural gas to a motion creating element;

Utilizing the motion creating element to reduce the pressure of the natural gas;

Communicating the turning motion into a power generating element; whereby the high pressure gas leaves the motion creating element having less pressure than when it was conveyed to the motion creating element.

### BACKGROUND OF THE INVENTION

This invention relates to technology for moving, storing, cleaning and natural gas. This invention also relates to a natural gas pumping unit and wellhead. The invention may further relate to such a method or system for reducing pressure of gas wellheads.

Even though the components are top of the line, the high pressure gas as it exists at wellhead can be greater than the capacity appropriate for the regulator and the pipeline. Gathering and transfer pipelines are built and intended to transport gas in low-pressure profiles. Thus, regulators at the wellhead must vastly reduce the pressure to transport the gas along low-pressure pipelines, and often operators, to reduce the pressure, must vent off excess natural gas to ensure the safety and performance of the regulator and components and pipeline. Therefore, a need exists to utilize the high pressure gas. A need further exists to reduce pressure from natural gas production that conveys to standard industry pipeline and infrastructure. A need even further exists for eliminating the venting of natural gas at the wellhead that is currently utilized, contributing unwelcomed loss of valuable natural energy into the atmosphere. A need further exists for better safety measures when dealing with high pressure gas production at the wellhead, which may otherwise cause unsafe risks to workers and surrounding environment.

### SUMMARY OF THE INVENTION

In one embodiment of the invention, a method for reducing gas pressure at or nearby a wellhead is claimed, the method for comprising providing an intake for high pressure natural, conveying the high pressure natural gas to a motion creating element, utilizing the motion creating element to reduce the pressure of the natural gas, communicating the turning motion into a power generating element; whereby the high pressure gas leaves the motion creating element having less pressure than when it was conveyed to the motion creating element; the motion creating element comprising an air motor; the air motor including a turbine; the motion creating element comprising a hydraulic accumulator configured to store energy in the form of pressure; the hydraulic accumulator communicating energy to a hydraulic motor; the method further comprising the step of repeating the steps until the high pressure gas reaches a selected outtake pressure and thus an outtake gas; the method further comprising the step of conveying the outtake gas for general processing; the method of further comprising the step of storing power created from the power generating element for use in an environment selected from the wellhead location, transmission back into a general electric grid, or storage.

In another embodiment, a system for generating power from the pressure differential of high pressure natural gas passing through an energy-creating element, the system comprising an intake line of a volume of high pressure natural gas, an energy creating element configured to reduce the pressure of the volume of high pressure gas and resulting in a low pressure gas, a of pressure from high pressure natural gas by the energy creating element; further comprising at least one sensor for temperature and/or pressure to input the state of a stream of natural gas; the energy creating element being an accumulator capable of conveying energy to a power generating element being a hydraulic motor; the energy creating element being an air motor; the air motor configured to create kinetic turning motion from the flow of the high pressure natural gas, whereby the motion creating element reduces the pressure of the natural gas to a status of a low pressure natural gas; the pump being configured to reduce the pressure of gas from an input pressure of 500-2500 lbs/sq. inch, to an output pressure of 25-500 lbs/sq. inch; the system configured to process the high pressure gas until it reaches a selected outtake pressure and thus an outtake gas; the system to process the high pressure gas until it reaches a selected outtake pressure and thus an outtake gas; the power generating element configured to dispose the power created from the power generating element for use in an environment selected from the wellhead location, transmission back into a general electric grid, or storage.

In yet another embodiment, a combination system with more than one energy creating element is disclosed.

Numerous objects and advantages of the invention will become apparent as the following detailed description of the preferred embodiments is read in conjunction with the drawings which illustrate such embodiments.

### BRIEF DESCRIPTION OF THE DRAWINGS

FIG. 1 depicts an illustration of an embodiment of the invention.

FIG. 2 depicts an illustration showing a flowchart depicting an embodiment of the invention.

### DETAILED DESCRIPTION OF THE PREFERRED EMBODIMENTS

The present invention solves many of the issues facing the energy production industry. Oil and gas wells often produce highly-pressurized flow at the wellhead, a mixture of liquids, gases and/or sediment. This creates a multitude of flow management challenges that result in suboptimal solutions, such as venting gases or otherwise allowing for inefficient handling of the highly-pressurized contents. The present invention resolves those challenges by lessening the pressure of the production line to a more manageable flow rate. The present invention may create power through the conversion of high to lower-pressure gas line. The present invention may reduce the danger of blowouts or other consequences of the high pressure lines and connections that result in downtime, lost production and negative environmental externalities. The invention may further utilize a high flow rate of natural gas line contents to turn a motor at a pump at or near a natural gas production site to generate power. The invention may even further use combinations of high flow rate to generate power.

At or near a wellhead in production of mixtures of high pressure natural gas, liquids and sediment, the present invention may comprise a matrix of gas lines, gauges, check and emergency release valves, and other connections. The inventive system and method shall describe further at least one or more depressurizing elements that can process pressurized natural gas into lower-pressure gas and useful power using a power management system, and in combination or independently at least one or more flow rate reducing elements.

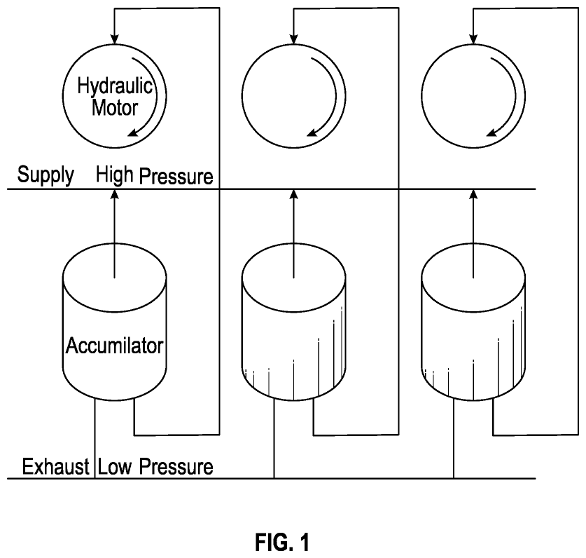

FIG. 1 depicts a flowchart of the inventive system and method for receiving and depressurizing raw natural gas contained within a series or matrix of gas lines. Other processing not pictured but known in the industry may take place in this system, such as water removal and other standard steps. Furthermore, other tools, controllers, connections and technology used in natural gas production are well-within the scope of this invention. One or more accumulators or accumulator pumps may be disposed on or connected to high pressure gas lines to utilize pistons, hydraulic bladders, or other return systems known in the arts of hydraulic accumulators to capture a portion of the pressurized contents of the gas line, reducing the pressure of the high pressure gas line. as known in the arts. The accumulator is shown in FIG. 1 to store the captured pressure as energy, and convey it to a hydraulic motor to convert it into useable power. As the reduced pressure gas line contents leave a first accumulator, it may enter into a second accumulator for additional reductive processing of the gas line contents. The accumulators may have a controller to program the operation, and may have mechanical operations disposed therethrough with valves, gauges, and other connections that may control the sequence, speed and ranges of the operations of the one or more accumulators. In yet another embodiment, the system in FIG. 1 may continue to reduce pressure in the gas line until the gas pressure is too low to transfer energy to the generator, or another limiting principle of the system prevents such conversion.

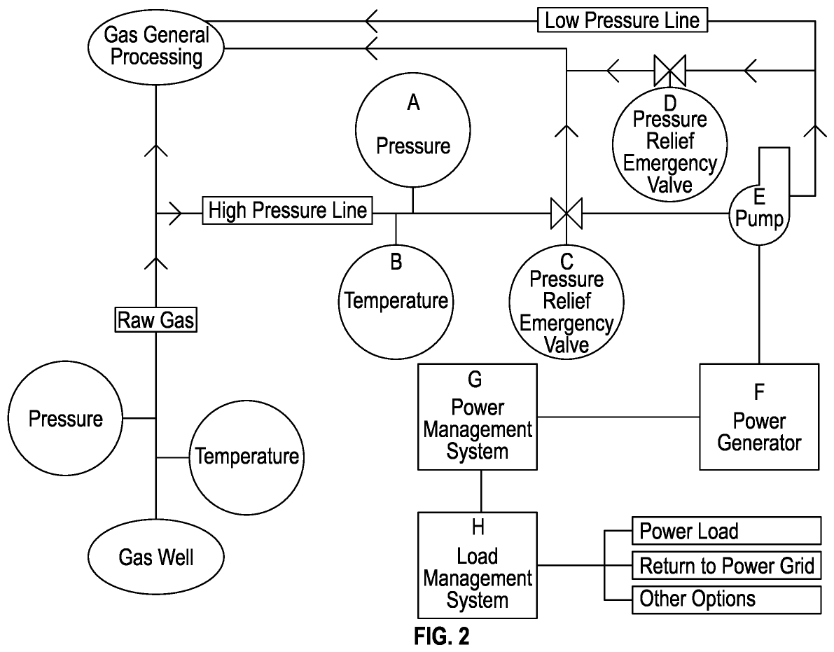

In another embodiment of the invention shown in FIG. 2, an inventive power management system is disclosed for use with a gas line with high flow rates that may also be pressurized. In this embodiment, may use an air motor to create a kinetic motion using the high pressure gas moving therethrough, utilizing a mechanical resistance to generate power at a power generator, manage the power at a power management element, and utilize a load management system to optimize the power load for use externally or internally.

In an embodiment of the invention that also may be reflected in FIG. 2, the inventive system may use an e pump to create electricity at a generator or nearby, the pump having a turbine and an axel. In this embodiment, the power management system communicates power from the turning of the turbine and axel between turbine and power generator.

Beginning at the lower left area of FIG. 2, a gas well (or a site of any natural hydrocarbon-based energy production) produces a combination of natural gas that may also contain fluids and/or solids. The raw gas then may optionally proceed through temperature and pressure sensors or checkpoints. If the gas pressure is of a sufficient pressure, it may be selected for diversion through a high pressure line. Optionally, temperature and pressure sensors A and B may then provide PID (photoionization) controls to monitor those levels. Within the high pressure diversion line, a pressure relief emergency valve C may be provided for relief in scenarios where the current inventive method fails to provide depressurization in the upstream high pressure line, or other systems fail, whereas the high pressure gas may be returned directly to the gas general processing systems generally in place and standard within the arts of managing produced natural gases and other associated fluids.

Following the high pressure line, the inventive system may include pump E to transform the pressure differential in mechanical force, redirecting the high pressure fluid to a power generator F. According to embodiments of the invention, the power generator may comprise a turbine configured to turn an axle, or utilize other means of communicating the kinetic turning motion to a generator to create electricity. The turbine may directly communicate the kinetic turning motion to other equipment onsite or nearby, such as a compressor. Any turbine known in the arts may be utilized within the scope of the invention, including a low torque turbine. In other embodiments of the invention, the profile of the fins may have other structural or geometric configurations to control torque levels. In yet other embodiments within the scope of the invention, the angle of the fins may be varied so that greater or lesser torque is used and thereby more or less pressure is depleted as selected.

Following the power generator F, power may be managed and controlled at the Power Management System G, which may convert power from DC to AC. The load management system may optimize the power into a current and ampere appropriate for further distribution. The load management system may enable the generation of power from the elements E-G to be loaded into external grids, or into other options as returned to for use internally, on storage, or otherwise for local use.

After the high pressure gas passes through the pump E, it may exit having a lower pressure than before entering the pump. Optionally, a downstream pressure relief emergency valve D may be disposed in the case that the pump E fails, diverting the gas having a pressure that exceeds the pressure relief emergency valve setting to the gas general processing hub. Otherwise, the downstream low pressure gas travels through a separate line, characterized in FIG. 1 as a low pressure line. In other embodiments, the line may continue to comprise high pressure or various materials and construction. The low-pressure line or downstream line may communicate the depressurized gas to the gas general processing. Because the depressurized gas has now been optimized for industry standard equipment, conduit and accessories, it may now be processed without venting excess gas into the atmosphere or, in other contexts, to a secondary reclamation system. In yet another embodiment, the system in FIG. 2 may continue to reduce pressure in the gas line until the gas pressure is too low to transfer energy to the generator, or another limiting principle of the system prevents such conversion. In this embodiment, the low pressure line may be later combined with higher pressure gas that bypasses the inventive system, so that it may reach a minimum pressure threshold for later use.

Focusing upon the embodiment of the invention that includes a turbine at the pump E, the turbine may turn an axle or other means of communicating the kinetic turning motion to a generator to create electricity. In embodiments not shown, the turbine may directly communicate the kinetic turning motion to other equipment onsite or nearby, such as a compressor. The system in FIG. 2 may also have a controller(s) to program the operation. The system may have mechanical operations disposed therethrough with valves, gauges, and other connections that may control the sequence, speed and ranges of the operations of the one or more accumulators.

In another embodiment of the invention, the system from FIG. 1 may be combined with the system from FIG. 2. A system such as illustrated in FIG. 2 may be utilized for the generating power, substituting the hydraulic accumulator in FIG. 1 at the point of E pump in FIG. 2. For example, the produced output from a natural gas wellhead is observed to be highly-pressurized, and also having a high flow rate of contents in CFM or by other measurements in the flow rate. The system from FIG. 1 may be tied into the system from FIG. 2 to form a combination system, so that the hydraulic accumulator system is reducing the pressure from the contents of the natural gas line. Within the same matrix, tied to an independent closed system, and/or running in parallel, the air motor or turbine system at the pump E of the Figure may be utilizing the high flow rate to capture the mechanical resistance described herein to generate power at that site.

In practice a method of generating power from produced natural gas lines may be disclosed in the following example. A high pressure line is observed at the wellhead with natural gas contents of 1000 lbs of pressure. Because most gas refineries prefer a much lower pressure to receive produced natural gas, an output of 100 lbs of line pressure is desired. The following steps may be utilized to achieve this reduction in pressure. First, the line contents are held in a high pressure line, and may be secured through the use of check valves, pressure relief valves, and other connections to prevent transfer to a general gas processing line or to the pump when it is not desirable to do so. Second, the natural gas in the high pressure line may interact with one or more accumulators configured to intake a portion of the fluid, pressure or air, store a portion of the fluid, pressure, or air and convert the stored pressure into power using a hydraulic motor. The natural gas may then proceed to interact with accumulators until the natural gas reaches the desired output of line pressure. Third, the natural gas with the desired output desired output of line pressure may be released to general proceeding.

In another embodiment, the following example addressses a method of generating power from produced natural gas lines that have a high flow rate. A high flow rate gas line is observed at the wellhead with natural gas production. Because most gas refineries prefer a much lower pressure to receive produced natural gas, an output of 100 lbs of line pressure is desired. The following steps may be utilized to achieve this reduction in pressure. First, the line contents are held in a high pressure line, and may be secured through the use of check valves, pressure relief valves, and other connections to prevent transfer to a general gas processing line or to the pump when it is not desirable to do so. Second, the natural gas in the high pressure line may interact with one or more pumps or air motors configured to interact with the flow of the contents of the high pressure gas line, mechanically turn or otherwise move a part of the motor, and then translate the movement to into power. The natural gas may then proceed to interact with e pumps until the natural gas reaches the desired output of line pressure. Third, the natural gas with the desired output desired output of line pressure may be released to general processing.

The preceding examples may be controlled within the system to the following example of calculating the torque needed by the turbine to deplete 900 lbs of pressure from the high pressure gas or storage. These levels are by example only and not for limitation. Actual ranges may span from 0 lbs of pressure to a maximally produced pressure in the gas line.
INPUT Starting pressure (PSI/CFM)— 1000 lbs
OUTPUT Final pressure needed by the refinery— 100 lbs

Other embodiments within the scope of the invention may be utilized to convert excess pressure to electricity. In another embodiment of the invention, a production unit that produces low amounts of national gas, that otherwise would be bled off eternally, may be affixed with a low pressure conversion system. In this embodiment, a output line may attach to the production unit that produces natural gas. The output line may connect to a gas compression or combustion engine that uses a low power. A regulator may be positioned between the combustion engine and a first side of the output line, to ensure that the pressure of gas entering the combustion engine does not exceed limitations.

In another embodiment of the invention, a system for use with a natural gas and/or oil pumping unit is within the scope of this application. In this embodiment, during the process of pulling up produced fluids, solids and gas, a piston(s) may be disposed to push up and thus the produced fluids, solids and gas may move the pistons or group thereof along a path and back to generate power at the power generation point of the system in FIG. 2.

In another embodiment of the pump in FIG. 2, a piston powered engine may utilize the high pressure gas to create a kinetic turning motion. The high pressure gas intakes into the piston chamber, pushes the piston, which may turn a shaft or axel. A valve at the intake may shut as the exhaust valve opens. The piston may return and pushes out the natural gas through exhaust port, returning the gas to the general gas processing line/pipeline. Optionally, a downstream pressure relief emergency valve D may be disposed in the case that the pump E fails, diverting the gas having a pressure that exceeds the pressure relief emergency valve setting to the gas general processing hub.

Other embodiments of the current invention will be apparent to those skilled in the arts from a consideration of this specification or practice of the invention disclosed herein. Thus, the foregoing specification is considered merely exemplary of the current invention with the true scope thereof being defined by the following claims.

What is claimed is:

1. A method for reducing gas pressure at or nearby a wellhead, the method for comprising
Providing an intake for high pressure natural;
Conveying the high pressure natural gas to a motion creating element;
Utilizing the motion creating element to reduce the pressure of the natural gas;
Communicating the turning motion into a power generating element; whereby the high pressure gas leaves the motion creating element having less pressure than when it was conveyed to the motion creating element.

2. The method of claim 1, the motion creating element comprising an air motor.

3. The method of claim 2, the air motor including a turbine.

4. The method of claim 1, the motion creating element comprising a hydraulic accumulator configured to store energy in the form of pressure.

5. The method of claim 4, the hydraulic accumulator communicating energy to a hydraulic motor.

6. The method of claim 1 further comprising the step of repeating the steps of claim 1 until the high pressure gas reaches a selected outtake pressure and thus an outtake gas.

7. The method of claim 6 further comprising the step of conveying the outtake gas for general processing.

8. The method of claim 1 further comprising the step of storing power created from the power generating element for use in an environment selected from: the wellhead location, transmission back into a general electric grid, or storage.

9. A system for generating power from the pressure differential of high pressure natural gas passing through an energy-creating element, the system comprising:
An intake line of a volume of high pressure natural gas
An energy creating element configured to reduce the pressure of the volume of high pressure gas and resulting in a low pressure gas;
A power generating element configured to receive the energy creating from the processing of pressure from high pressure natural gas by the energy creating element.

10. The system in claim 9 further comprising at least one sensor for temperature and/or pressure to input the state of a stream of natural gas.

11. The system in claim 9, the energy creating element being an accumulator capable of conveying energy to a power generating element being a hydraulic motor.

12. The system in claim 9, the energy creating element being an air motor.

13. The system in claim 12, the air motor configured to create kinetic turning motion from the flow of the high pressure natural gas, whereby the motion creating element reduces the pressure of the natural gas to a status of a low pressure natural gas.

14. The system of claim 9, the pump being configured to reduce the pressure of gas from an input pressure of 500-2500 lbs/sq. inch, to an output pressure of 25-500 lbs/sq. inch.

15. The system of claim 9 configured to process the high pressure gas until it reaches a selected outtake pressure and thus an outtake gas.

16. The system of claim 9 configured to process the high pressure gas until it reaches a selected outtake pressure and thus an outtake gas.

17. The system of claim 9, the power generating element configured to dispose the power created from the power generating element for use in an environment selected from: the wellhead location, transmission back into a general electric grid, or storage.
